(19) United States
(12) Patent Application Publication
(10) Pub. No.: US 2004/0237030 A1
(43) Pub. Date: Nov. 25, 2004

(54) System and method of implementing calculation fields in an electronic form

(76) Inventor: Wayne Allan Malkin, Edmonton (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/441,241

(22) Filed: May 19, 2003

(51) Int. Cl. G06F 15/00

(52) U.S. Cl. 715/505

(57) ABSTRACT

A system and method provide for implementing calculation fields in electronic forms. The system and method enables the calculation fields to be designed and implanted without requiring a user to know a computer executable language capable of implementing the calculations. Instead, the system and method produce, from user inputs to a graphical user interface, an object descriptive of the calculation. From the descriptive object, automated tools are able to generate computer executable code for implementing the calculations. The generated computer executable code enables simple and complex calculations, and may be executed using standard software that is widely distributed as part of popular operating systems and web browsers.

### BACKGROUND OF THE INVENTION

1. Field of the Invention

Embodiments of the invention generally relate to electronic forms.

2. Description of the Related Art

Organizations have long used forms to provide a standard format for recording information. Generally, forms have been printed on paper and filled out by hand. Paper form use and entry, however, suffers from many drawbacks. For example, paper forms are often messy, sometimes have illegible information, provide no mechanism for checking the accuracy of information entered, and the like. As such, organizations have sought ways to allow individuals to fill out forms in electronic formats. The widespread acceptance and use of computer networks, including everything from relatively straightforward computing devices communicating with one another, to the Internet or World Wide Web (“the Web”), has motivated organizations to seek ways to implement electronic forms that are accessible over these networks. For example, organizations often desire to implement electronic forms that are creatable, modifiable, completable, storable, and the like through that organization's computing systems.

One known method of implementing electronic forms accessible via at least the Web includes relying on the formatting features of the HyperText Markup Language (“HTML”), the formatting code of the Web. Web browser software generally supports HTML and therefore can be used to display forms created using HTML. However, many of the advanced features of HTML are not implemented in a standard way across different Web browsers. Thus, a form generated directly in HTML may not display uniformly on every user's browser. Furthermore, even including its advanced features, HTML does not have the precision necessary to define a form with high-fidelity, such that the electronic form will be close to or actually uniformly true to a paper original. In many circumstances, electronic versions of the forms should be reproducible within a very small degree of deviation from a set standard. For example, government tax or other forms should be reproduced with a high degree of fidelity. As disclosed in the foregoing, HTML is often incapable of generating high-precision forms over different Web browser platforms.

A popular method of distributing high fidelity and other documents over computer networks is generally known as Portable Document Format (“PDF”). To view a PDF form, an individual generally needs only a version of Adobe Acrobat® Reader®, a relatively inexpensive proprietary software program of Adobe Systems Incorporated (“Adobe”). However, Adobe Acrobat® Reader® does not allow an individual to generate, manipulate, modify or even complete a PDF form. Rather, each user desiring to perform the foregoing activities has to install another more expensive proprietary software program called Adobe Acrobat®. Thus, proper access and installation across a computer network of an electronic forms management system using PDF generally includes ensuring each user have access to relatively expensive and complex proprietary software, managing the proprietary software to ensure implementation of uniform or at least compatible versions of the proprietary software, often expensive and/or complex computing devices, and the like. Thus, distributing forms over a computer network as PDF documents can be a complex and costly process.

Other methods of distributing electronic forms over computer networks suffer from many of the same disadvantages. Generally, methods of distributing electronic forms require the installation of software on a desktop client. Thus, some electronic form distribution relies on browser plug-ins. This approach requires the installation of additional software to a browser and are not generally supported by a wide number of client computer systems. Other electronic form distribution relies on Java applets. This approach requires a user to download software (the applet) to his or her computer. On many computers, Java applets do not run well, and require a great amount of administrative resources to organize the distribution of compatible applet versions throughout an organization.

Additionally, existing electronic form distribution systems do not provide adequate tools for allowing a client computer to associate calculation and validation logic with fields of an electronic form. Client-based calculation and validation support in known form distribution systems require a user to understanding complex computer language syntax, such as, for example, the syntax of Java, JavaScript, Visual Basic, and the like. While these and similar languages are capable of performing calculations and validations, they are not generally accessible to computer users that are most likely to design forms, such as, for example, business managers.

Embodiments of the present invention seek to overcome some or all of these and other problems.

### SUMMARY OF THE INVENTION

Based on the foregoing, a need exists for systems and methods of processing electronic forms which provides for high-fidelity reproduction through straightforward and less complex computing software, such as, for example, Web browsers. Moreover, a need exists for implementation of such forms in a manner allowing non-programmers the ability to generate often complex electronic forms, including for example, calculations, data validations, other business logic, images, text, input sections, and the like.

In an embodiment, an electronic forms management system implements forms that can be viewed and manipulated with a high degree of fidelity, using HTML tools found in most popular web browsers. These forms may be layered to include graphical elements, control or input/output elements, and logic elements. Each layer, the graphic layer, the control layer, and the logic layer, may be implemented using tools that are supported in most web browsers, such as, for example, Graphics Interchange Format (“GIF”) images, HTML with Cascading Style Sheets (“CSS”), and JavaScript. Thus, according to embodiments of the present invention, no client-side software is necessary, beyond software already supported by most web browsers, for displaying and manipulating high-fidelity electronic forms.

In an embodiment, an electronic forms management system implements electronic forms using multiple layers or layered aspects. For example, in one embodiment, the electronic forms management system renders electronic forms using three layers, i.e., a graphic layer generally including the text, graphics, images, and the like, a control layer generally including data representations, inputs, output, and the like, and a logic layer generally including data validations, calculations, or other business logic.

In an embodiment, the graphic layer provides a background image of a blank form, including pictures, drawings, text, boxes, lines, and generally those visually fixed objects or aspects of the form. The control layer provides a mechanism for transparently or otherwise overlaying input or data embodiments onto the form. For example, in one embodiment, the borders of the input or data embodiments are transparent, such that users see the input or data aspects “bordered” by the appropriate boxes, lines, etc. of the graphic layer. The logic layer provides a mechanism for calculating or validating input to the form.

According to an embodiment, the electronic form management system includes one or more form designers, a form server, and one or more user devices. The form designer comprises a software client program that guides a user/designer through the generation of a form. The form designer can include tools for straightforwardly adding data validation or calculation embodiments to the form. As will be further disclosed, in one preferred embodiment, the layering of the form into multiple layers, for example, three layers, is performed largely by the form server. When a user/client desires to access the form through the client device, such as, for example, to modify the form, enter or correct data, or the like, the form server encodes the multiple layers into a high-fidelity form delivered via a Web page. According to one embodiment, the high-fidelity form is rendered using standard HTML elements positioned and made transparent using standard Cascading Style Sheets (“CSS”) features. The form may also include scripts written in, for example, JavaScript, and generated automatically from encoded business logic and form object properties.

Based on the foregoing, embodiments of the electronic forms management system advantageously allow high-fidelity forms to be distributed, completed, and modified without installation of expensive software, significant administrative costs associated with managing software licenses, installation, and upgrades, or acquisition of relatively complex computing devices.

For purposes of summarizing the disclosure, certain embodiments, advantages and novel features of the invention have been described herein. Of course, it is to be understood that not necessarily all such embodiments, advantages or features will be embodied in any particular embodiment of the invention.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 illustrates a simplified diagram of multiple layers of an electronic form, according to an embodiment of the invention;

FIG. 2 illustrates a simplified block diagram of an electronic form management system, according to an embodiment of the invention;

FIG. 3A illustrates a flowchart of an exemplary layering process performed by the electronic management system of FIG. 2;

FIG. 3B illustrates a simplified block diagram of an exemplary form template of the electronic form management system of FIG. 2;

FIG. 4 illustrates a flowchart of an exemplary rendering process performed by the electronic management system of FIG. 2;

FIG. 5 illustrates a simplified block diagram of an exemplary form designer of the electronic form management system of FIG. 2;

FIG. 6A illustrates a simplified block diagram of an exemplary form server of the electronic form management system of FIG. 2;

FIG. 6B illustrates a simplified block diagram of a form template and form renderer of the form server of FIG. 6A;

FIG. 7 illustrates a simplified block diagram of an exemplary user device of the electronic form management system of FIG. 2; and

FIG. 8 illustrates an exemplary electronic form, according to an embodiment of the invention.

FIG. 9 illustrates one embodiment of a form design process that may be performed by a form designer.

FIG. 10 illustrates an exemplary user interface of a form designer, according to an embodiment of the invention.

FIG. 11 illustrates an exemplary user interface of a field association tool for associating a calculation with a form field, according to an embodiment of the invention.

FIG. 12 illustrates an exemplary form template created by a form designer, particularly illustrating one embodiment of a calculation object within the form template.

FIG. 13 illustrates an exemplary parse object tree that is generated by the parser of the form server, according to an embodiment of the invention.

FIG. 14 illustrates an exemplary scripted calculation as implemented in the logic layer of the electronic form, according to an embodiment of the invention.

### DETAILED DESCRIPTION OF THE PREFERRED EMBODIMENT

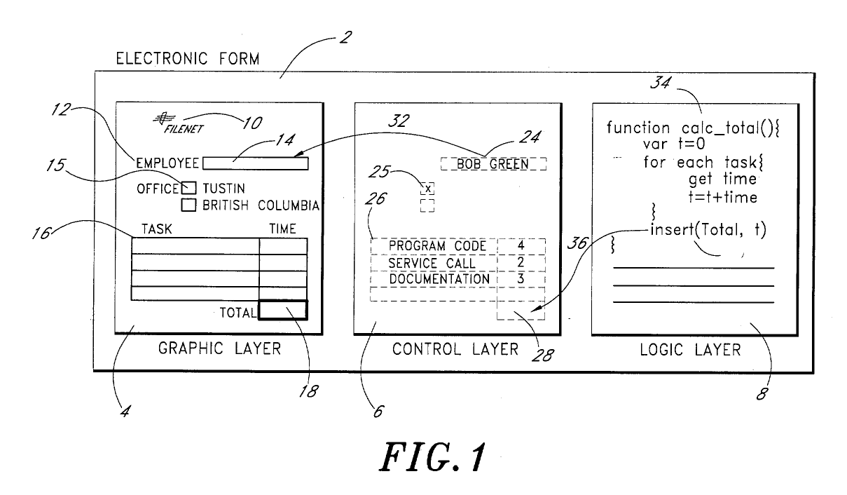

FIG. 1 illustrates a simplified diagram of multiple layers of an electronic form 2, according to an embodiment of the invention. As shown in FIG. 1, the simplified diagram of the electronic form 2 may represent a simplified employee time sheet from FileNET® corporation. The form 2 comprises a graphic layer 4, a control layer 6, and a logic layer 8. As shown in FIG. 1, the layers of the electronic form 2 can be thought of as being physically stacked one above another such that input/output elements of the control layer 6 overlay and are properly positioned in framed graphical elements from the graphic layer 4. Moreover, the logic layer 8 includes calculation or validation elements to provide or validate information in the form, such as code designed to fill the “Total” box shown in the graphic layer 4.

In one embodiment, the graphic layer 4 comprises a graphical representation of an unfilled form, i.e., the graphic layer 4 represents an electronic encoding of graphical elements that make up a form. For example, the graphical elements or aspects may include text, boxes, lines, diagrams, charts, tables, photographs, drawings, logos, other graphical elements, or the like. Several graphical elements are illustrated in FIG. 1 in the graphic layer 4, such as, for example, a graphic image of a logo 10, a text label 12, frames for data entry as boxes 14 and 18, frames for check box 15, frames for table 16, and the like.

It is noteworthy that each graphical element of the graphic layer 4 can be implemented with particular definable and highly accurate dimensions, can be of particular color, and can be placed at a particular location. Thus, the graphic layer 4 comprises a reproducible image of the form having fidelity identical or substantially identical to that of an original form. As disclosed in the foregoing, many organizations, particularly governmental agencies, impose strict standards on the reproduction of various forms. These standards may be imposed for any number of reasons, including enabling the forms to be automatically scanned and read by automated form reading technology. Advantageously, the encoding of the graphical layer 4 into an image, ensures that these standards are met with a high level of fidelity. Thus, the graphical encoding of the graphical layer 4 can, in one advantageous embodiment, define for each graphical element the size, the location, the color and the like of the element.

Although disclosed with reference to identical or near identical fidelity, an artisan will recognize from the disclosure herein that for some applications, compliance with identity may not be a primary concern. For example, a user may primarily be concerned with rapid output rather than high fidelity reproduction. Thus, the disclosure is not limited to identical or near identical fidelity, and alternative embodiments may provide for lower levels of reproduction identity.

In one embodiment, the graphic layer 4 can be encoded using a graphical encoding format displayable and printable using standard software products widely and cost-efficiently available to a wide range of computer users. Typically, such standard programs may be distributed with popular operating systems, such as Microsoft® Windows®, or with popular web browser software such as Microsoft® Internet Explorer, Netscape® Navigator®, or the like. An artisan will recognize from the disclosure herein a number of graphical encoding formats that are freely and easily accessible to a large number of computer users without requiring the installation of additional software, such as, for example, graphics interchange format (“GIF”), Joint Photographic Experts Group (“JPG,” or “JPEG”), tagged image file format (“TIFF”), Portable Network Graphics (“PNG”), the standard bitmap graphics format (“BMP”), EMF, Scalable Vector Graphics (“SVG”), PDF, or the like. In one preferred embodiment, the graphic layer 4 is encoded using standard GIF. As will be understood by an artisan, a number of readily available software tools exist for encoding a graphical image into the foregoing graphic formats, including the preferred GIF.

It is noteworthy that GIF images are often displayed according to a set standard, and accordingly, GIF images displayed on or printed from one computing system often will be substantially similar to or the same as that GIF image displayed on or printed from another different computing device. Thus, the encoding of the graphic layer 4 in a standard graphic format such as GIF ensures that the graphic layer 4 can be consistently reproduced and remain true or substantially true to its specification in the electronic form, even across a wide range of computer platforms.

In an embodiment, the control layer 6 comprises data representing input/output elements from the form 2, such as, for example, the fillable blanks of the graphic layer 4. As shown in FIG. 1, each blank from graphic layer 4 may have an input and/or output field correspondingly defined on the control layer 6, such that were the control layer 6 to be layered with the graphic layer 4, the input elements 24, 25, 26 and 28 will align with their framed graphic boxes, tables, and the like, respectively 14, 15, 16 and 18, from the graphic layer 4. Moreover and as disclosed in further detail in the following, the data residing in a calculation box 28 may be automatically filled in based on a calculation performed by the logic layer 8.

As disclosed in the foregoing and shown in FIG. 1, the inputs of the control layer 6 are spatially aligned with the blanks of the graphic layer 4. Additionally, borders of the input/output elements of the control layer 6 may be advantageously transparent. Moreover, text and positioning within each input/output element may be configured with an appropriate font size, style, color, and the like to control the fidelity of the form 2.

In one preferred embodiment, the control layer 6 is encoded using HTML elements and associated Cascading Style Sheets (“CSS”) attributes. An artisan understands that CSS is an HTML extension that is widely supported by web browser software. Moreover, CSS is generally capable of defining, for any given input field, the attributes of the field, including positioning, font style, font size, font color, and the like. Additionally, the transparent input fields of the control layer 6 may be defined using CSS. Although CSS is an emerging standard and certain CSS features may not be supported by all CSS versions an artisan will recognize that the embodiments of the graphic layer 4 and the control layer 6 may be implemented with, for example, a core group of CSS features that are widely supported across most CSS versions. However, an artisan will recognize from the disclosure herein that the control layer 6 may use certain CSS features that are not supported by all CSS versions. The form server 52 may take this into account, rendering forms using CSS features supported by a requesting browser. Additionally, a mechanism may be provided for distributing or allowing the distribution of CSS versions that support any desired features. In addition to CSS, the control layer 6 may be implemented using other encoding schemes generally available in the relevant art.

FIG. 1 also shows the logic layer 8. The logic layer 8 generally includes code for performing data calculations, validations, and the like. For example, FIG. 1 shows an exemplary function, calc_total 34, illustrated in pseudocode, for summing the time entered in the table 16.

The calculation of a total time to insert into control layer 6 is only one exemplary calculation that may be performed by the logic layer 8, and is not intended to limit the present disclosure. Rather, the logic layer 8 may perform any number of calculations, validations, and the like. For example, the following calculations may be performed by the logic layer 8:

Validation: The logic layer 8 may include calculations for validating, or checking the correctness of, certain entries on the control layer 6. For example, with respect to FIG. 1, logic layer 8 may include a function that validates that “Bob Green” is the name of an employee of FileNET®. For example, the logic layer 8 may compare “Bob Green” to a list of valid employee names. Alternatively, the logic layer 8 may query a database of employee names to determine whether “Bob Green” exists. The logic layer 8 may also be configured to perform validation calculations of varying degrees of complexity. While the look-up validation operations described may be relatively simple, the logic layer 8 may also perform more complex calculations, such as replacing a commonly used name, pulling data from other forms or other data sources, providing suggestions when errors are found, generating help guide information, combinations of the same, or the like.

The logic layer 8 may perform a calculation to ensure that numbers are entered into the time field of the control layer 6. For a date field on an accident claim form, the logic layer 8 may validate that the date is in the past, as future accidents may be presumed to be invalid. On the other hand, for a date field for a form for scheduling a conference room, the logic layer 8 may validate that the date is in the future, as a meeting scheduled for the past may be presumed to be invalid.

Validation calculations such as those diclosed in the foregoing may be expressed in the form designer 50a as scripts such as JavaScripts, alebraic expressions such as those used in spreadsheets, or as properties of objects. One example of a validation expressed in an object property is a boolean property “Required” field. A client may perform a validation to ensure that all required fields have been filled in by a user. Any of these expressions of validation logic may be converted into a computer executable language, such as, for example, JavaScript, for execution in a client computer.

As will be recognized by an artisan from the disclosure herein a particular user may choose to perform a limited number of calculations, no calculations, or a variety of different calculations. Thus, the presence of the logic layer 8 does not require that any calculations are performed.

As disclosed, the logic layer 8 may include instructions on how to respond when a user enters data that is deemed to be invalid. For example, the logic layer 8 may reject a particular input and require the user to reenter information when, for example, the user enters a text string into a field that requires a numerical value. The logic layer 8 may also propose alternative entries; prompt the user to enter alternative entries, or provide choices for entries, such as, “Do you mean Robert P. Green? Y/N.” In addition, the logic layer 8 may allow a user to override the validation calculation and enter information even though it is deemed by the logic layer 8 to be invalid.

Date Calculation: In addition to the foregoing, a date may be automatically calculated or validated by the logic layer 8. For example, an organization may have a policy that requires all sales representatives to perform one or more activities before and/or after each sale. Thus, a sales representative may enter a sale into a form, along with a date of sale. The logic layer 8 may then generate one or more of the foregoing activity dates and automatically, or with user acceptance, insert them into fields.

Form Serialization: Commonly, organizations may want to produce forms that have unique identification numbers. Invoices, for example, typically have an invoice number. Accordingly, the logic layer 8 may perform operations that add an invoice number to a form by, for example, incrementing a stored invoice number, accessing invoice number data, or the like.

Numeric Calculations: The form 2 may also include fields that are calculated numerically from inputs to other fields, from external values, or the like. For example, the total time field 18 of FIG. 1 may be calculated as the sum of the values in the time column, may be the sum from one or more forms, or the like. Another example may include a property tax calculation. Thus, a user may enter the value of his or her home. Then, the logic layer 8 may determine the property tax percentage for that valuation and/or may calculate the tax owed on the property. One of ordinary skill in the art will appreciate from the disclosure herein that any number of mathematical functions may be supported by the logic layer 8, including basic or sophisticated math functions, basic or sophisticated statistical functions, other data processing calculations, and the like.

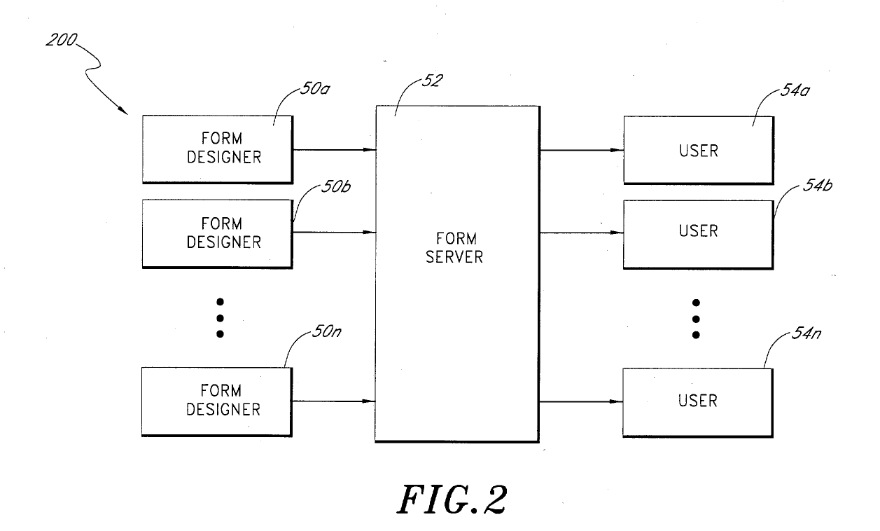

In FIG. 1, the function calc_total 34 of the logic layer 8 is expressed in pseudocode for purposes of illustration, not limitation. Advantageously, the logic layer 8 includes computer executable language for expressing some of the previously disclosed calculations, all of the previously disclosed calculations, other calculations, or combinations of the foregoing calculations. In one embodiment, the computer executable language of the logic layer 8 comprises a computer executable language that is widely distributed with popular operating systems such as Microsoft® Windows® and MacOS or popular web browsers such as Microsoft® Internet Explorer and Netscape® Navigator®. In one preferred-embodiment, the logic layer 8 is encoded in JavaScript, though alternative widely distributed computer executable languages are known artisans and may be employed. As will be discussed in further detail with respect to FIGS. 2-8, a graphical tool may facilitate a user designing logic and may automatically convert a user's interactions with the graphical tool into executable JavaScript. For example, a user may interact with a user-friendly form design tool including drag and drop tools, spreadsheet-like relational calculation tools, word processing tools, and the like. In such an environment, the form design tool may generate the more complex code and/or script. By providing the form design tool, a highly accurate electronic form 2 can be produced by workers with little or no computer programming expertise.

A skilled artisan will recognize from the disclosure herein that virtually any computer executable language known or that may become known may be useable in the logic layer 8 with or without the aid of a graphical development tool.

In one preferred embodiment, the graphic layer 4 is encoded using a standard GIF image, the control layer 6 is encoded using standard HTML cooperating with standard CSS for positioning and graphical control of HTML elements, and the logic layer 8 is encoded using standard JavaScript. Each of these encoding schemes can be interpreted using standard tools that are widely distributed with popular operating systems and web browsers. As such, the layered form 2 encoded in this fashion can be combined into a single form, displayed, and printed at almost any user terminal, without the installation of additional software while maintaining high-fidelity reproduction at minimal cost and installation complexity. Thus, an organization may advantageously adopt this electronic form distribution system without worrying about high cost, low form fidelity, or the inability of an end user to view, print, or enter information into the electronic form 2.

Although disclosed with reference to certain preferred and alternative embodiments, the layered approach described herein may include various graphics standards, style controls standards, and computer executable languages other than or in addition to the foregoing GIF, CSS, and JavaScript. Preferably, alternative designs take into account the advantages of using a standard with a wide level of distribution to minimize the costs and complexities of manipulating electronic forms. Nevertheless, for some applications, implementing the graphic layer 4, control layer 6, or logic layer 8 using tools that are not as widely accessible may be appropriate. Moreover, an artisan will recognize from the disclosure herein that the layers may be combined into fewer layers or expanded to many layers without detracting from many of the advantages disclosed herein.

FIG. 2 illustrates one embodiment of a computer network 200 capable of manipulating forms, such as, for example, the electronic form 2 described in the foregoing. As shown in FIG. 2, the network 200 can include one or more form designers 50a through 50n, a form server 52, and one or more users 54a through 54n. In one embodiment a designer of a form develops an electronic form such as, for example, the electronic form2, using form designer 50a. Form designer 50a may include a user-friendly interface for creating a form description by manipulating objects representing the graphical elements, input/output elements, and calculations of the form. As shown in FIG. 2, the form designer 50a may communicate, through any known means of electronic communication, with the form server 52. In one embodiment, the form server 52 may store form descriptions and may render the form descriptions into layered forms, such as the layered form 2 of FIG. 1. As shown in FIG. 2, the form server 52 may communicate, through any known means of electronic communication, with one or more users 54a through 54n. In one embodiment, a user 54a requests a form from the server 52. In response to this request, the form server 52 may transmit to user 54a a layered form 2. User 54a may include software for displaying the form, completing the form, printing the form, storing the form locally, transmitting the form to the form server 52 for storage, and the like. While the illustrated embodiment includes one form server 52, an artisan will appreciate in light of the foregoing disclosure that the tasks of the form server 52 can be distributed among multiple servers for various purposes, such as, for example, load balancing.

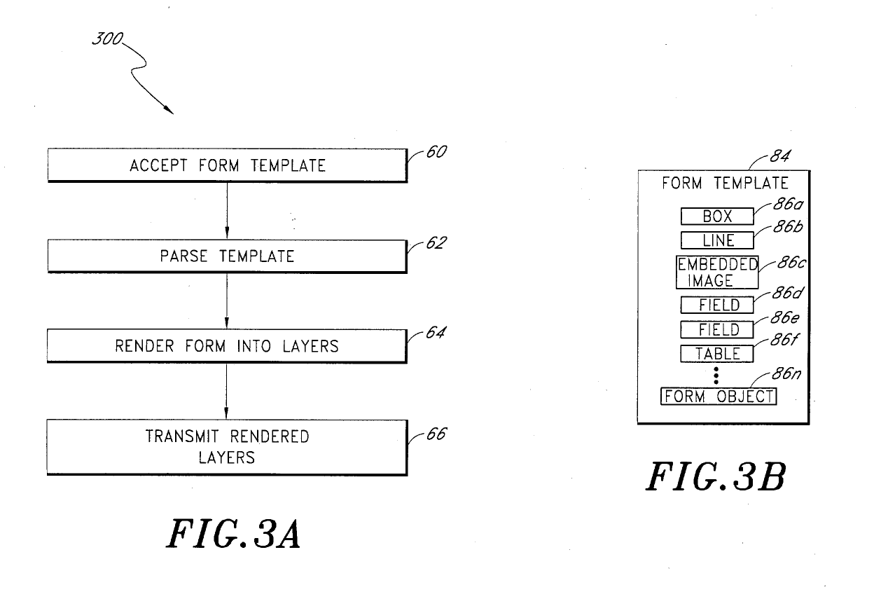

FIG. 3A illustrates one embodiment of a rendering process 300 implemented, for example, on the form server 52, for rendering layers from a form template 84 (FIG. 3B). In a block 60, the form server 52 accepts the form template 84. As illustrated in FIG. 3B, the form template 84 contains a number of form objects 86a through 86n descriptive of a form. Exemplary form objects 86a through 86n include boxes 86a, lines 86b, embedded images 86c, fields 86d and 86e, and tables 86f. One of ordinary skill in the art will appreciate from the disclosure herein that additional form objects 86a through 86n may be stored in the form template 84, and generally include all graphical and textual elements for describing a form. Generally, the form server 52 may store each form template 84 until a user 54a requests a form.

In one embodiment, the form server 52 performs a block 62, a block 64, and a block 66 after a form is requested by a user 54a. Thus, in this embodiment, a layered form 2 is created upon the request of a user 54a. Advantageously, this embodiment may allow for the manipulation of forms that may change from time to time. For example, graphics, such as logos, form styles, fonts, colors, and the like may change from time to time. By creating a layered form 2 each time it is requested by a user 54a, the most recent revisions of form objects 84a through 84n may be incorporated into the form 2 at the time that the user 54a requests a form. Alternatively, one or more of the layers, or certain portions of the layers, may be pre-rendered as part of the creation of the form template 84 in the form designer 54a. For example, the graphic layer 4 may be rendered within the form designer 54a, and may be embedded as an image into the form template 84. This approach may be advantageous when a particular form designer 54a has greater capability than does the form server 52, of representing certain graphical elements, such as particular fonts.

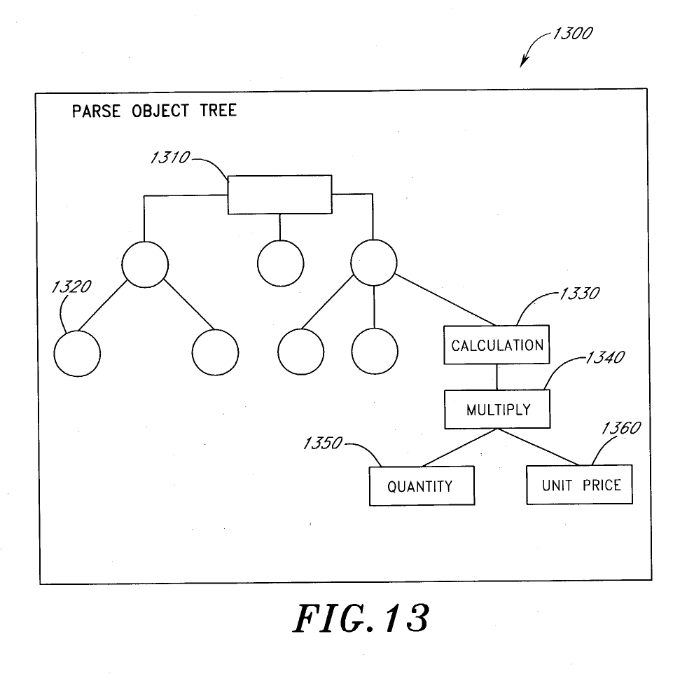

In the block 62, the form server 52 parses the form template 84 to prepare the form objects 86a through 86n for orderly processing. In one embodiment, the form server 52 may organize the form objects 86a through 86n into a parse object tree structure such as, for example, the parse object tree 1300 illustrated on FIG. 13, such that each form object 86a through 86n may be represented by a node of the tree. A skilled artisan will appreciate, from the disclosure herein, that alternative data structures exist for allowing the orderly processing of the form objects 86a through 86n, including various tree structures, linked lists, arrays, file directories, and the like.

After parsing the form template 84, form server 52 renders the form into layers in the block 64, generating a layered form 2. In one embodiment, the block 64 includes an orderly processing of each of the form objects 86a through 86n, such as, for example, by traversing a parse object tree. Each form object 86a may be associated with the graphic layer 4, the control layer 6, or the logic layer 8, or with two of the layers, all of the layers, or none of the layers. The rendering of each layer may proceed serially, and the rendering of each layer may takes as input, the ordered data structure, such as a parse tree generated in block 62. Generally, the rendering of each layer may include the separation, from the general parse tree, of those form objects 86a through 86n associated with the layer. For example, form objects 86a through 86n that form part of the graphic layer 4 may be used for the rendering of graphic layer 4. Alternatively, the rendering of each layer may proceed in parallel.

At a transmitting block 66, the three rendered layers are transmitted to a site for form generation. In one embodiment, the site to which the rendered layers are transmitted is a user computer 54a. Alternatively, the site to which the rendered layers are transmitted may be within the form server 52. For example, the rendered layers may be stored on form server 52, for later retrieval by a user computer 54a through 54n.

As disclosed, while one form server 52 is illustrated, the tasks of the form server 52 may be distributed among multiple servers.

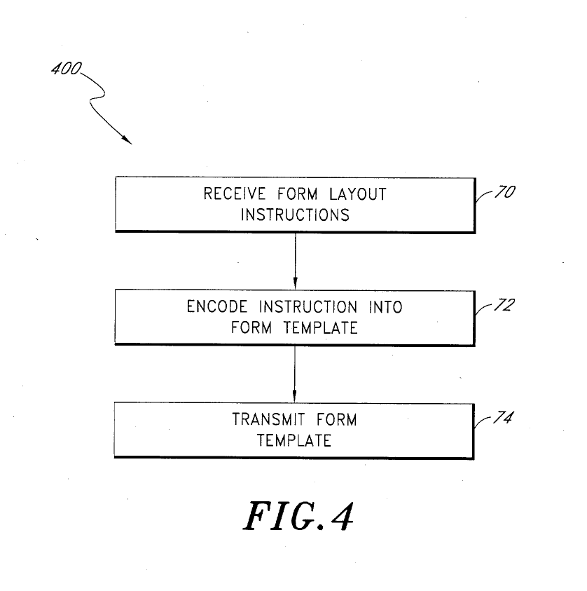

FIG. 4 illustrates one embodiment of a design process 400 for designing a form template 84. The design process 400 may be implemented on the form designers 52a through 52n. In a block 70, the form designer 52a receives form layout instructions. In one embodiment, form layout instructions are received from a user through interactions with a graphical user interface, such as, for example, the user-friendly interface described in the foregoing. In an embodiment, the form layout instructions are entered by a user in the form of text commands descriptive of a form. In another embodiment, the user's entry of form layout instructions may include the scanning of a paper form or graphic that may form part or all of the background image for the form. In yet another embodiment, the user's entry of the form layout instructions may include a combination of some or all of these input methods, all of these input methods, or additional known data input methods. In a block 72, the form layout instructions may be encoded into a descriptive form template, such as, for example, the form template 84. In a block 74, the form template may be transmitted to a site for further processing. In one embodiment, the form template 84 may be transmitted to the form server 54. However, the form template may be transmitted to one of the form designers 52a through 54n for future retrieval and processing, or the like.

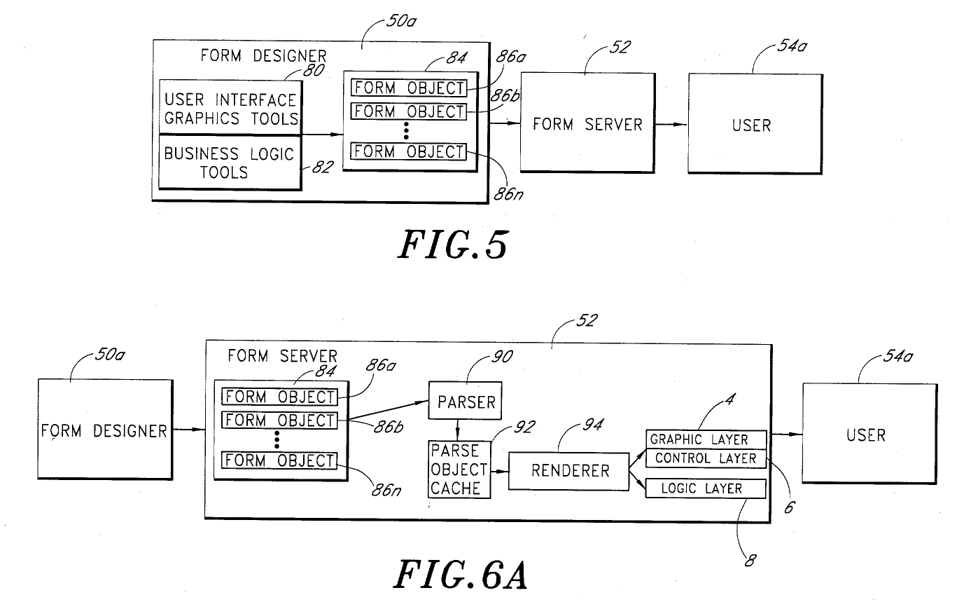

FIG. 5 illustrates one embodiment of the form designer 50a. As shown in FIG. 5, the form designer 50a may include user interface graphics tools 80 and business logic tools 82. The user interface graphics tools 80 and the business logic tools 82 may cooperate to generate the form template 84. The user interface graphics tools 80 may be a set of graphical layout tools that enable a user to graphically draw the layout of a form. Graphical layout tools generally include text and graphic manipulation applications, tools for creating presentations, desktop publishing applications, or the like. Among popular graphical drawing tools are commercially available applications such as Adobe® Photoshop® and Microsoft® Powerpoint®. In one preferred embodiment, the user interface graphics tools 80 are configured to create and modify an Extensible Markup Language (XML) document. XML is an object description language that is well-adapted for describing the individual objects that make up an electronic form.

As a user interacts with the user interface graphics tools 80, the user is creating a series of objects that will make up an electronic form. For example, a user may select a tool that enables the user to draw a box, drag the box to a specific location on the page, resize the box and select the color of the box according to the specification of the form. The user interface graphics tools 82 capture the user's interactions, interpret those interactions as particular inputs for the characteristics of, for example, a text input box, and generate a box object that describes each characteristics of the box. The box object is then added to the form template, such as the form template 84.

Similarly, a user may select a tool for creating a table. The tool may enable the user to draw the table, place the table at a specific location, resize the table, select the color of the table, and the like. Additional tools may allow the user to add or delete columns and/or rows to the table. The user interface graphics tools 82 capture the user's interactions, interpret the interactions and generate a table object, such as, for example, the table object 86f, that describes each characteristic of the table.

Similarly, the user interface graphics tools 80 may include tools for creating form objects 86a through 86n associated with the control layer 6. Advantageously, elements associated with the control layer 6 may be integrated into form objects 86a through 86n along with graphic elements and logic elements. Thus, a form object such as the field object 86d may have encapsulated position, dimension, color, graphical properties, and logic elements. Additionally, control elements may be encapsulated in separate form objects, may be associated with multiple graphic or logic elements, or any combination of the foregoing.

The business logic tools 82 enable a user to add logic and calculations to the design of the form. Thus, a user may construct a calculation to be performed through a series of interactions with the business logic tools 82. For example, a user may construct business logic that adds all numbers in one column in a form to produce a total value. Referring to FIG. 1, a total calculation associated with total box 18 may be created as follows: (1) the user selects a “sum” function, (2) the user selects a field into which the result of the sum function is to be placed, in this example, box 18, (3) the user selects a series of fields that are the inputs to the sum function, in this case the four fields above box 18, and (4) the user selects a command that indicates that construction of this particular mathematical function is complete. Upon completion of function construction, the business logic tools 82 convert the user's interactions into form objects 86a through 86n that are descriptive of the desired calculations and validations.

As illustrated by FIG. 5, after generating the form template 84, the form designer 50a may transmit its output, including the form template 84, to the form server 52. The form server 52 performs further processing on the form template 84 and transmits its output to the user 54a.

While the foregoing discloses embodiments of the form designer 52a in which a user interacts directly with the form designer 52a, an artisan will appreciate, in light of the foregoing, that the form designer 52a may additionally comprise an automated design tool that receives input from various automated sources, such as, for example, a database. For example, according to one embodiment, the form designer 52a may receive multiple input checklists from a form database. The input checklists may contain basic fields, attributes, controls, logic elements, and the like that are to be included in each form. Based on the data in the input checklists, the form designer 52a may automatically generate multiple form templates, such as, for example, the form template 84. This batch processing may advantageously be employed to enable an organization to create a large number of forms quickly, without focusing on every layout detail of each form. Additionally, a user may use interactive features of the form designer 84a, to fine tune, add details, and modify details of a particular form, such as, for example, by resizing or moving a particular field. An artisan will appreciate, in light of the foregoing, that the form designer 54a may comprise any number of user interactive design features, any number of automated design features, or any combination of user interactive design features and automated design features.

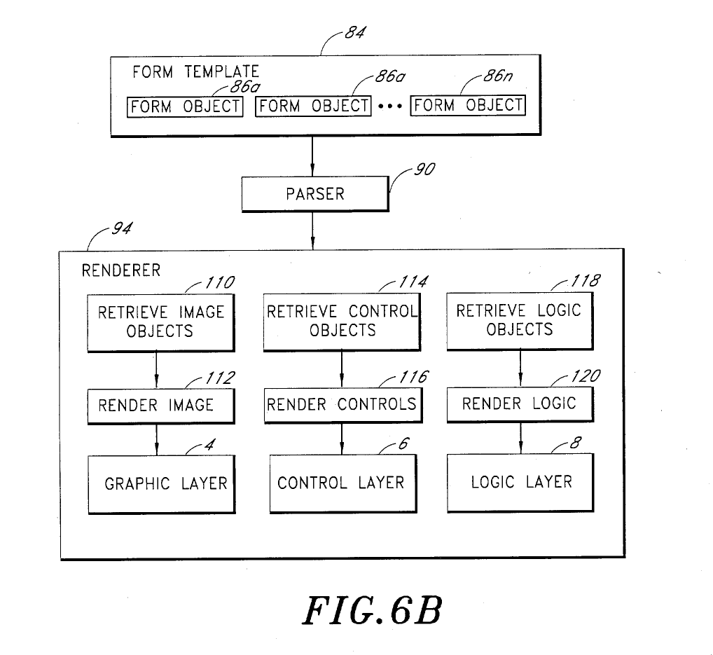

FIG. 6A illustrates a simplified block diagram of an exemplary form server 52 of the electronic form management system of FIG. 2. As illustrated, the form server 52 receives the form template 84 from the form designer 50a. As disclosed in the foregoing, one embodiment of the form template 84 stored in the form designer 50a includes storage via XML objects. The form server 52 parses an XML object into a parse object tree using the parser 90 and stores the tree in a parse object cache 92. In one embodiment, the parse object tree 1300 comprises a main form node, dividing into one or more form elements, which may be further subdivided into additional elements, such as ordered calculations or the like.

The parse object cache 92 comprises computer readable or accessible storage media that provides convenient access to the parse object tree 1300. When a user requests a specific form, the renderer 94 receives the parse object tree 1300 from the parse object cache 92. Generally, the renderer 94 performs a plurality of rendering steps on the parse object tree 1300. Thus, in one preferred embodiment, the caching of the parse object tree 1300 results in faster computation by the renderer 94. In one embodiment, the renderer 94 may traverse the parse object tree 1300 multiple times, such as, for example, one time for each layer of the form, to render the layers of the form.

According to one embodiment, the renderer 94 renders forms at the request of a user, to cache forms expected to be requested by a user, recently requested by a user or the like. During a rendering process, as shown in FIG. 6A, one embodiment stores the graphic layer 4 and the control layer 6 of each page of a form grouped together and the logic layer 8 for the entire form also grouped together. Although disclosed using a particular grouping, an artisan will recognize from the disclosure herein many potential groupings and cache protocols that can be implemented using the form server 52.

FIG. 6B illustrates a simplified block diagram of a form template and form renderer of the form server of FIG. 6A. As illustrated, the renderer 94 performs separate rendering passes on the parse object tree 1300. In one rendering pass, the renderer 94 retrieves form objects 86a through 86n that are associated with the graphic layer 4 of the form from the parse object tree 1300. Then, the renderer 94 renders a background image of the form in a block 112. In one embodiment, the rendering of the background image is done by converting the image objects 86a through 86n into a GIF image. In another embodiment, there may be only one large GIF image representing the entire background image of the form that is stored as one of the form objects 86a through 86n. In this embodiment, this single GIF image has been pre-rendered by the form designer 50a at the time of form design. This approach may be advantageous where it is not known what graphical support a particular form server 52 offers, and one wants to ensure that a particular graphical element that is available on the form designer 50a, such as a particular font, successfully becomes part of the GIF image. On the other hand, delaying the rendering of the graphical image such that it is done for the first time by the renderer 94 of the form server 52 provides for greater flexibility, as recent changes to a particular form element are incorporated into the graphic layer 4 at the time of rendering. The rendered background image comprises the graphic layer 4 of the form 2.

In another rendering pass beginning with block 114, the renderer 94 retrieves the form objects 86a through 86n that are associated with the control layer 6 of the form from the parse object tree 1300. In a block 116, the renderer 94 renders input controls associated with the form. In one embodiment, the rendering of the input controls is done by converting the control objects 86a through 86n into a series of HTML elements with associated CSS attributes that properly align the input controls on the form. Alternatively, another style language known to one of ordinary skill in the art may be used. As illustrated, the rendered input controls comprise the control layer 6.

In another rendering pass, beginning with a block 118 the renderer 94 retrieves the form objects 86a through 86n that are associated with the logic, calculations, and validation of the form from the parse object tree 1300. The renderer 94 renders executable computer language instructions that perform the desired calculations, in a block 120. In one embodiment, the rendering of the logic is done by converting the logic objects 86a through 86n into a series of JavaScript statements that perform the desired calculations. Alternatively, another executable computer language known to one of ordinary skill in the art may be used. As illustrated, the rendered calculations comprise the logic layer 8.

Based on the foregoing, the form server 52 advantageously renders an electronic form according to the layered approach described herein. Additionally, the form server 52 may serve as a repository for various forms, and may transmit each form based on requests from the users 54a through 54n. As will be appreciated by an artisan, this transmission of forms by the form server 52, in accordance with the layered approach, enables the user 54a to display, manipulate, and print each form in high-fidelity using standard software products.

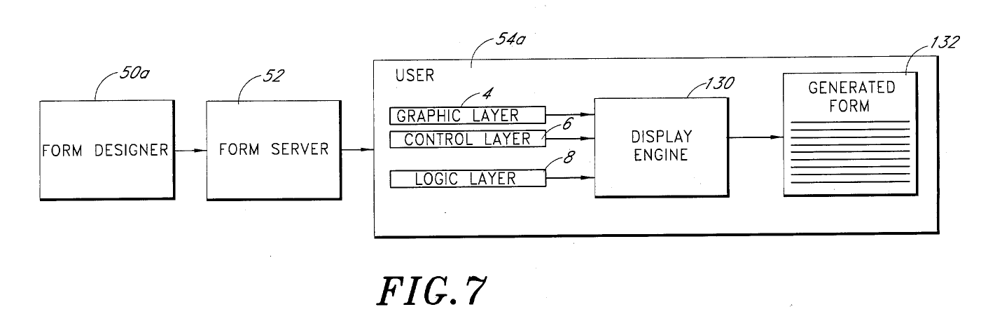

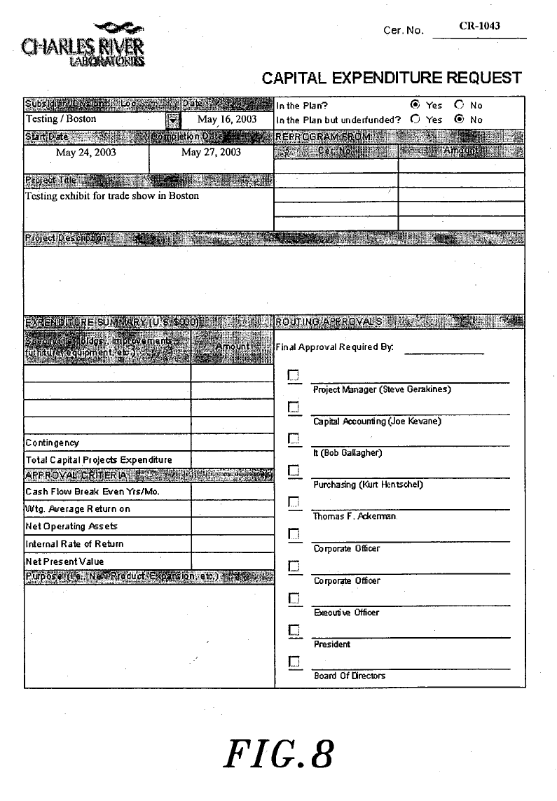

FIG. 7 illustrates a simplified block diagram of an exemplary user device of the electronic form management system of FIG. 2. In one embodiment, the transmitted graphic layer 4, the control layer 6, and the logic layer 8 may represent an unfilled form. In another embodiment, the transmitted graphic layer 4, control layer 6, and logic layer 8 may have some values filled in to the control layer 6. In an embodiment, form aspects that have previously been either partially or completely filled-in may be stored in the form server 52. These stored form aspects may comprise data values that pertain to particular fields of the form, and may be stored in any computer readable medium, including computer files, database fields, nodes of a parse object tree, or another medium. The previously filled in values may be transmitted from form server 52 along with the three layers 4, 6, and 8. Also, certain default values may be automatically filled into the form and transmitted along with the three layers 4, 6, and 8. Also, previously filled in values or default values may be stored in and retrieved from the user computer 54a.

In one embodiment layers 4, 6, and 8 are received by a display engine 130. The display engine 130 is configured to combine the graphic layer 4, the control layer 6, and the logic layer 8 to create a single displayable and printable form. In one embodiment, display engine 130 displays the graphic layer 4 with an overlaid control layer 6. Thus a user is able to view both graphic layer 4 and transparent control layer 6, such that it appears to be a single form. A user inserts information into the form 2 through control layer 6. The user may, for example, type information into boxes that accept string data, such as input box 24 of FIG. 1. As a user inserts information into the control layer 6, the information is visibly overlaid over the graphic layer 4. The inserted information is also displayed on the generated form 132 when the form is complete. Additionally, as the user inputs information into the control layer 6, the logic rules of the logic layer 8 are applied. In this way, all three layers of the form are combined by the user computer 54a, resulting in a generated form 132 that can be displayed, information entered, and printed. Advantageously, the combination of the layers and the generation of a single form 132 is accomplished using standard display tools that are distributed with many popular operating system and/or web browser software. In one embodiment, display engine 130 is a standard HTML display engine.

For illustrative purposes only, and not by way of limitation, various embodiments described herein have illustrated the manipulation of simplified, one-page forms. An artisan will understand, in light of the disclosure herein, that multi-page forms may be designed, rendered, and manipulated in accordance with the foregoing. According to an embodiment, the user device 54a may include a mechanism for ensuring that information entered by a user into one page of a multi-page form is retained when a user switches to a different page. For example, in one preferred embodiment, the user device 54a may employ an HTML frameset for storing entered data. The logic layer 8 and any data entered into the form may be rendered to a primary or parent frame of an HTML window. The HTML window may also include an HTML <frameset> element, including a child frame comprising the graphic layer 4 and the control layer 6 of the page. Additionally, other child frames may be created to support controls for moving back a page, moving forward a page, skipping to any page of the form, or the like. In this arrangement, the parent frame and any child frames may be associated with each other, such that a consistent representation of the entire form may be maintained. When any page switch occurs, such as, for example, the user selects a page forward control, the graphic layer 4 and the control layer 6 of the new page may be loaded into the viewed child frame, while the logic layer 8 and data entered into the form are maintained in the parent frame.

According to an embodiment, the user device 54a may also cooperate with the form server 52 to ensure that information entered by a user into one page of a multi-page form is retained when a user switches to a different page. For example, all three layers 4, 6, and 8, along with data entered into the form, may be stored in a single window. When a page switch occurs, the user device 54a may post the entered data to the form server 52. The form server 52 may render a new page, incorporating the entered data posted by the user device 54a. An artisan will appreciate, in light of the foregoing, that additional approaches for maintaining information entered by a user exist. An artisan will appreciate, in light of the foregoing, that each approach may have distinct advantages and disadvantages. For example, the first approach described herein may advantageously result in fewer accesses to the form server 52, while disadvantageously using frames, which are not universally supported by web browsers. The second approach described herein, however, does not use frames, but may result in many more accesses to the form server 52.

The user device 54a may include storage to enable a user to store an unfilled, a partially filled, or a completely filled form. Such storage may comprise any computer-readable medium, including a computer file, a database, a content management system, or the like. The storage may be located at one or more of any site, including, without limitation, the user device 54a, another user device 54b through 54n, the form server 54, another computer located on the computer network 200, or portable storage devices such as, for example, a ZIP disk. Additionally, the user device 54a may enable a user to retrieve, at a later time, the stored information, for further manipulation, display, and printing.

FIG. 8 illustrates an exemplary electronic form produced using the layered approach described herein. As illustrated, a form produced using the layered approach described herein may be relatively complex, including a number of text entry boxes, a number of checkboxes, some radio buttons, a graphical logo, different styles and sizes of fonts, highlighted fields, bolded fields, and tables. Though FIG. 8 is a representative example of a typical form, it is not meant to demonstrate the extent of the complexity that can be achieved using the layered approach. Indeed, the layered approach is extendable to produce a form of virtually any desired level of complexity.

As disclosed in the foregoing, an electronic form may be designed using a form designer. The form designer produces a form template that is descriptive of the form. The form server receives the form template, parses the form template, and renders the form template into the graphic layer, the control layer, and the logic layer. The three layers may be manipulated, displayed, and printed using the graphic engine of the user computer.

As disclosed, in one embodiment the design of an electronic form and creation of the form template can be accomplished using user interface graphics tools 80 and business logic tools 82 within the form designer 50a. Collectively, these design tools 80 and 82 enable a user to use standard tools of a graphical user interface to design a form. For example, a user may use the design tools 80 and 82 to add and manipulate box objects, line objects, field objects, circle objects, text objects, table objects, and the like. Additionally, the business logic tools 82 enable a user to graphically associate calculations and validation information with particular fields of the form, using techniques familiar to users of spreadsheet programs, such as, for example, Microsoft® Excel®. The business logic tools 82 translate the user inputs into a descriptive object language, such as, for example, XML. The descriptive object language enables parsing and rendering, in the form server 52, of executable computer language commands that implement the calculations and validations. Typically, the executable computer language commands may not be easily understood by a computer user that is not familiar with or adept in computer programming. Thus, the business logic tools 82 advantageously enables a user to create and manipulate calculations and validations using a familiar interface similar to that found in spreadsheet programs.

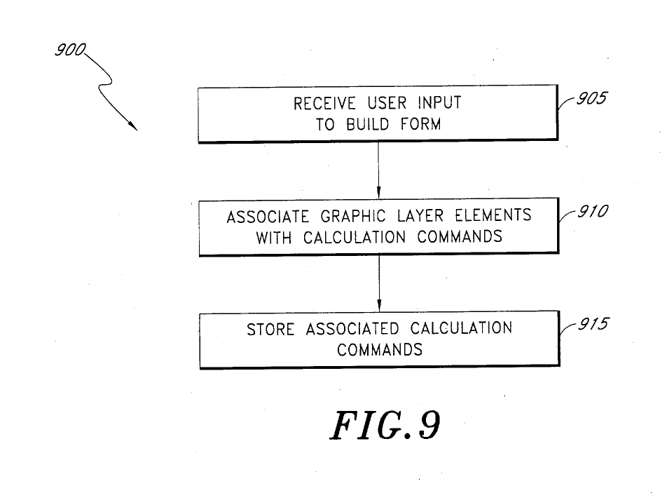

FIG. 9 illustrates a design process 900 performed by, for example, the form designer 50a of FIG. 5. The design process 900 includes a block 905 in which the form designer 50a receives user input to build a form, a block 910 in which the form designer 50a associates elements of the graphic layer 4 with calculation commands of the logic layer 8, and a block 915 in which the form designer 50a stores the associated calculation commands.

According to one embodiment, in the block 905, the form designer 50a receives user input to build a form. The user interface graphics tools 80 and the business logic tools 82 may be configured to receive this user input. In the block 910, the form designer 50a associates elements of the graphic layer 4 with calculation commands of the logic layer 8. For example, in an embodiment, the form designer 50a may employ the business logic tools 82 to accomplish this association. In the block 915, the form designer 50a stores the associated calculation commands using, for example, the business logic tools 82. The form designer 50a may store the associated calculation commands, for example, into the form template 84. Thus, through the foregoing process, a user can advantageously create sophisticated forms, including value calculations, data validations, and the like, without the need for advanced computer programming experience.

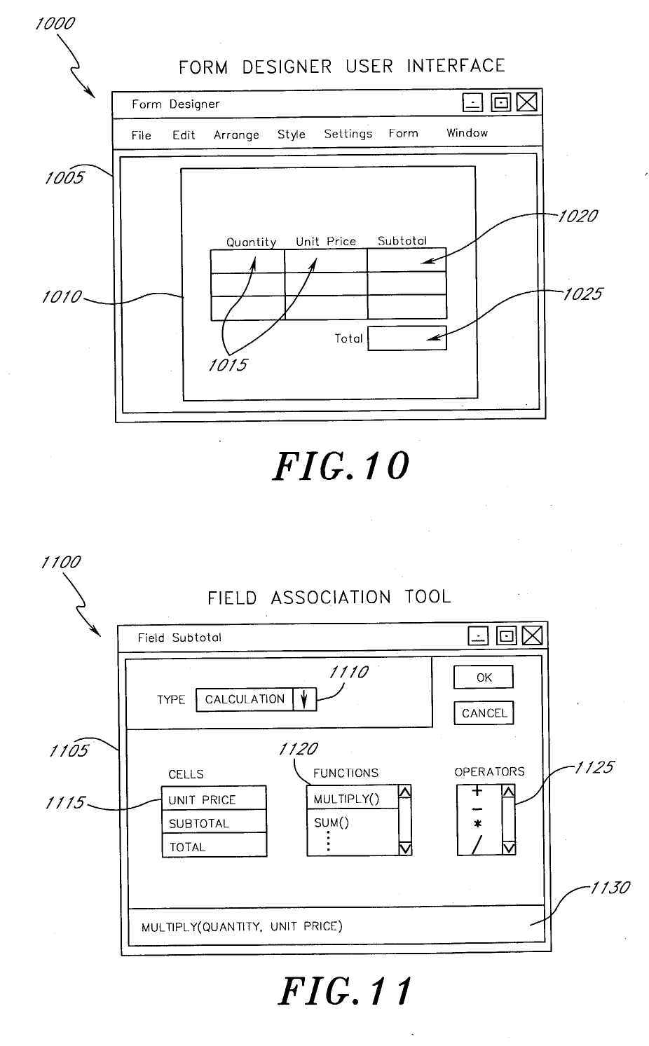

FIG. 10 illustrates an exemplary user interface 1000 of the form designer 50a. As shown in FIG. 10, the user interface 1000 comprises a window 1005, a work area 1010, a plurality of user input fields 1015, a subtotal calculation field 1020, and a total calculation field 1025. The window 1005 includes various graphical tools for enabling a user to select commands, such as a tool bar, menus, and other tools of a typical graphical user interface. In one embodiment, the work area 1010 defines the boundaries of the design area of the form. The work area 1010 may display the form with substantially the same elements, dimensions, colors, margins, and the like as the form would print. Additionally, the work area 1010 may enable a user to focus on particular portions of the form, such as, for example, a table that a user is editing. Moreover, the work area 1010 may enable additional views, such as views at any number of zoom levels, rotated views, views with certain elements highlighted, and the like.

The work area 1010 may also include a variety of elements definable as fields. For example, the user input fields 1015 define fields configured to receive user input. The user input fields 1015 may be configured to receive a particular type of user input, such as, for example, a number, a date, a monetary value, a description or other string, or any other input that may be received into a paper or electronic form. For example, in the exemplary work area 1010, the user input fields 1015 labelled “Quantity,” and “Unit Price,” may be configured to receive a numeric value and a monetary value, respectively. Additionally, the user input fields 1015 may be configured to provide tools to aid a user in entering information into the fields, such as, for example, a pick list with multiple choices of possible entries.

The subtotal calculation field 1020 and the total calculation field 1025 define calculation fields configured to contain the results of a calculation. Each calculation field may receive user inputs entered into other fields, such as user input fields 1015, or external inputs, such, as information stored, for example, in an external database. The subtotal calculation field 1020 may be configured to contain the product of the “Quantity” and “Unit Price” user input fields 1015, as illustrated. The total calculation field 1025 may be configured to contain the sum of subtotals contained in the subtotal calculation field 1020. Thus, a calculation field, such as, for example, the total calculation field 1025 may receive, as input, information stored in a field that is, in itself, a calculation field, such as the subtotal calculation field. Advantageously, the form designer 50a may include rules for the order in which calculation fields are calculated, such that the value of a calculation field that is dependent on another calculation field is not prematurely, and erroneously, calculated.

A field may have attributes of both user input fields and calculation fields. For example, as disclosed in the foregoing, a user may associate validations with a particular user input field. Generally, a validation is a class of calculation configured to verify that information entered into a field follows certain validation rules. Thus, user input fields such as the user input fields 1015 may have validation rules to ensure that the “Quantity” and the “Unit Price” are positive values. In this case, the user input fields 1015 would both receive user inputs and perform the validations. Additionally, calculation fields such as the subtotal calculation field 1020 and the total calculation field 1025 may be configured such that a user can selectively disable calculations and enter a value manually. Such a feature may be useful, for example, to calculate a suggested or default value, but allow a user to override the default.

FIG. 11 illustrates an embodiment of a field association tool 1100 that a user may use to associate any number of the foregoing field attributes to a particular field. Illustratively in FIG. 11, a user may use the field association tool 1100 to manipulate attributes of a “Subtotal” field. The field association tool 1100 comprises a window 1105, a type selector 1110, a cell/field list 1115, an assignable function list 1120, a simple operator list 1125, and a calculation commands box 1130. The window 1105 comprises graphical user interface controls similar to those disclosed with reference to the window 1005. The type selector 1110 comprises a list of field types, including calculation, date, constant value, user-supplied value, auto-increment, and the like. A user may select a type from the type selector 1110. Generally, such a selection may define the selected field as a field of the selected field type, such that the field type determines the source of the field's data. For a user-supplied field, a value is supplied by a user. For a calculation, a value is calculated as defined by the calculation formula entered by a user. The field type may dictate which functions and/or which operators are shown and available for association with one or more fields. For example, for a user-supplied field, no functions and no operators may be displayed, because it is not a calculation field. For a calculation field, a wide range of functions and operators may be available. For an auto-increment type, a user may be prompted to enter a source from which a new number is generated.

The cell/field list 1115 may comprise a list of any number of fields of the form. In one advantageous embodiment, the cell/field list 1115 includes every field of the form. The cell/field list 1115 may be scrollable, such that a portion of the list is presented at any one time. Additionally, the cell/field list 1115 may indicate a selected field, such as, for example, by highlighting. Moreover, the cell/field list 1115 may allow a user to select one or more of the fields, using controls as supported in typical graphical user interfaces. In one advantageous embodiment, selection of a field from the cell/field list 1115 corresponds to the inclusion of the selected field in a calculation.

The assignable function list 1120 may comprise a list of any number of functions that may be included in a calculation. In one advantageous embodiment, the assignable function list 1120 includes every function that has been defined and can be rendered by the form server 52. Moreover, the assignable function list 1120 may be configured to display, in addition to pre-defined functions, user-defined functions. The assignable function list 1120 may be scrollable, such that a portion of the list is presented at any one time. Additionally, the assignable function list 1120 may indicate a selected function, such as, for example, by highlighting. Moreover, the assignable function list 1120 may allow a user to select one or more of the functions, using controls as supported in typical graphical user interfaces. In one advantageous embodiment, selection of a function from the assigned function list 1120 corresponds to the inclusion of the selected function in a calculation.

The simple operator list 1125 may comprise a list of any number of operators that may be included in a calculation. In one advantageous embodiment, the simple operator list 1125 includes every operator that has been defined and can be rendered by the form server 52. The simple operator list 1125 may be scrollable, such that a portion of the list is presented at any one time. Additionally, the simple operator list 1125 may indicate a selected operator, such as, for example, by highlighting. Moreover, the simple operator list 1125 may allow a user to select one or more of the functions, using controls as supported in typical graphical user interfaces. In one advantageous embodiment, selection of a function from the assigned function list 1125 corresponds to the inclusion of the selected function in a calculation.

The calculation commands box 1130 may display a calculation, as it is being constructed, in an algebraic notation similar to that adopted by popular spreadsheet programs. Thus, as illustrated, the calculation commands box 1130 may display, for example “Multiply(Quantity, Unit Price)” to indicate that the calculation is a multiplication function of the “Quantity” field and the “Unit Price” field. Thus, the calculation commands box 1130 presents the calculation to the user in a format that is generally understood by a large number of computer users unfamiliar with computer programming syntax, such as, for example, users of popular spreadsheets. Advantageously, the calculation commands box 1130 may enable a typical user to verify that his or her interactions with the field association tool 1100 are resulting in the desired calculation.

Thus, as will be appreciated by an artisan in light of the foregoing disclosure, the components of the field association tool 1100 may be configured to work together to enable an unsophisticated computer programer to enter, manipulate, and develop logic of even complex calculations or data verifications.

FIG. 11 also illustrates the use of the field association tool 1010 to associate a calculation with a “Subtotal” field. As illustrated, a user has selected the “calculation” type using the type selector 1110. Additionally, a user may have selected, from the assignable functions list 1120, the “Multiply” function. A user may have additionally selected, from the cell/field list 1115, the “Quantity” field, and the “Unit Price” field. Thus, assuming the performance of these exemplary events as described, the user may have associated the calculation with the “Subtotal” field using a handful of mouse clicks or any other input device to make his or her selections. Moreover, the user may have directly typed some or all of the calculation command into the calculation commands box 1130. In one embodiment, the graphical nature of the interface of the business logic tools 82 enables each of these and additional convenient and quick data entry methods, as will be appreciated by an artisan in light of this disclosure.

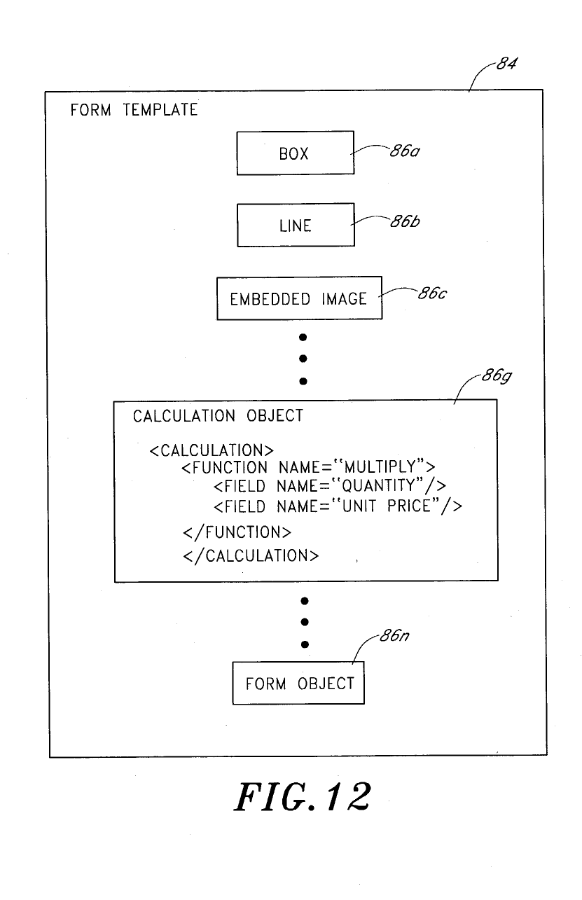

FIG. 12 illustrates an exemplary form template 84 created by the form designer 50a, particularly illustrating one embodiment of a calculation object 86g. As disclosed in the foregoing, the form designer 50a generates the form template 84, comprising form objects 86a through 86n descriptive of a form. As disclosed, these form objects 86a through 86n may include boxes, lines, embedded images, fields, tables, calculations, and any other object that may be associated with a form. As disclosed, in one embodiment, the form template 84 may be encoded using XML or a similar object description language.

As shown in FIG. 12, calculation object 86g may be employed to represent the exemplary calculation commands of FIGS. 10-11. For example, a tag may identify certain calculation objects. For example, the illustrated tag may be of type “<calculation>.” Following this tag, the calculation object 86g may comprise any number of encoded lines that identify variables, functions, operators, fields, constants, and any other item that may be used in a calculation. As illustrated, the calculation object 86g may comprise a line identifying a function for implementing the multiplication operator, a line identifying “Quantity” as an input field to the multiplication operator, and a line identifying “Unit Price” as another input field to the multiplication operator. Additionally, functions and operators may be identified separately or used interchangeably. That is, the “Multiply” function may operate in substantially the same fashion as the “*” operator. Alternatively, the “Multiply” function may perform differently in some degree than the “*” operator.

The descriptive calculation object 86g of FIG. 12 is by way of illustration only, and does not define the exact syntax of the descriptive language illustrated. Rather, an artisan will appreciate, in light of the disclosure herein, that any number of descriptive syntaxes may be adopted that may effectively describe a calculation object. Advantageously, the structure of the descriptive calculation object may enable the form server 52 to efficiently render the descriptive calculation object into a computer executable set of instructions. For example, one advantageous characteristic of the illustrated descriptive syntax is that the components of the calculation, including fields, variables, functions, operators, and the like, may be arranged in a tree like structure, as is illustrated in FIG. 12.

Furthermore, while the calculation object 86g is illustrated as separate from other form objects 86a through 86n, the code of the calculation object 86g may form part of other form objects 86a through 86n. In one preferred embodiment, the code illustrated by calculation object 86g may be encapsulated into one or more of the form objects 86a through 86n. For, example, a field object 86d may correspond to the illustrated “Subtotal” field. This field object 86d may include the graphic, control, and logic aspects of the “Subtotal” field, including dimensions, font size, color, location, and the calculation associated with the field. Additionally, certain types of fields may include associated attributes that automatically invoke certain default calculations or validations. For example, one attribute may be a “Required” attribute that indicates that a user should not skip the field. Validation to ensure that a user enters information into a field may be implicit for such “required” fields. That is, a default portion of code may be generated, by the renderer 94, to perform such a validation, without explicit validation instructions in the form template 84. Alternatively, explicit validation instructions may be inserted into the form template 84.

FIG. 13 illustrates an exemplary parse object tree 1300 that may be generated by the parser 90 of the form server 52. As disclosed in the foregoing, a parse object tree 1300 may comprise a root node 1310 and a plurality of nodes 1320, each node representing an attribute of the form. As disclosed, the represented attributes may pertain to one or more of the graphic layer 4, the control layer 6, or the logic layer 8. FIG. 13 particularly illustrates several nodes 1330 through 1360 of the parse object tree 1300 that are representative of a calculation. The represented calculation, as illustrated, may correspond to the calculation object 86g of the form template 84 of FIG. 12, and comprises a calculation root node 1330, a “Multiply” function node 1340, a “Quantity” field node 1350, and a “Unit Price” field node 1360. An artisan will appreciate in light of this disclosure that the structure of the parse object tree 1300 may correspond directly to the structure of the form template 84. Advantageously, such a correspondence enables an efficient translation, by the parser 90 of the form server 52, from the form template 84 to the parse object tree 1300. Nevertheless, an artisan will appreciate, in light of this disclosure, that the parse object tree 1300 may correspond in varying degrees to the form template 84.

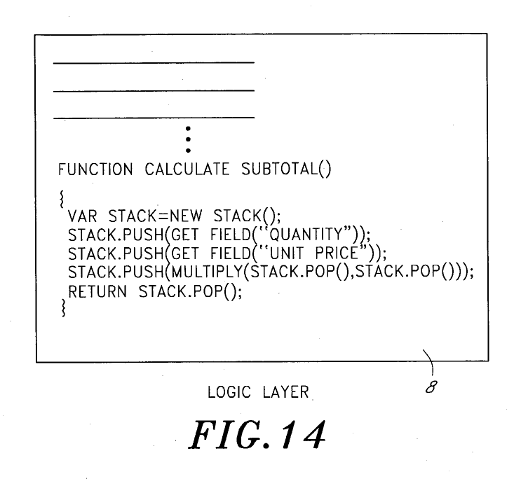

FIG. 14 illustrates an exemplary calculation as implemented in the logic layer 8 of the electronic form 2. Illustratively, the function “Calculate SubTotal” is laid out in pseudo-JavaScript. As will be appreciated by an artisan in light of this disclosure, the calculations could be implemented in a wide variety of computer executable languages, including JavaScript. Illustratively, function “Calculate SubTotal” makes use of a set of functions for manipulating a stack, a “GetField” function for retrieving the value of a field, and a “Multiply” function for multiplying two numbers. Advantageously, stack-based calculations can be rendered in a simple yet efficient manner by the renderer 94. As will be appreciated by an artisan in light of this disclosure, the function of FIG. 14 may be rendered by simple association of each calculation node of the parse object tree 1300 of FIG. 13 with a single line of code in the logic layer 8 of FIG. 14. As will be further appreciated, the ordering of the code may be determined by a post-order traversal of the parse object tree 1300.

Advantageously, a one-to-one correspondence between logic elements of the form template 84 and the parse object tree 1300, and between the parse object tree 1300 and the logic layer 8 calculation functions, enables quick, simple, and efficient translation one representation of a calculation to another. As such, one advantageous embodiment maintains this one-to-one correspondence in order to simplify the translational process. Nevertheless, a skilled artisan will appreciate in light of this disclosure that many mechanisms, of varying levels of complexity, may be employed for performing the translations.

As will be appreciated by an artisan in light of the foregoing disclosure, each calculation field may depend on values entered into other fields of a form. For example, on the form illustrated on FIG. 10, the “Subtotal” calculation field 1020 may depend on the “Quantity” and “Unit Price” fields 1015. The “Total” calculation field 1025 may depend on the individual cells of the “Subtotal” calculation field 1020. An artisan will appreciate in light of the foregoing disclosure, that a user may change the value of a field, such as, for example, the “Quantity” field, resulting in a change of the value of a calculation field, such as the “Subtotal” calculation field 1020 that depends on the changed field. An artisan will further appreciate in light of the foregoing disclosure, that a change in one calculation field, such as the “Subtotal” calculation field 1020, may result in a change of another dependent calculation field, such as the “Total” calculation field 1025.

Advantageously, changes in the values of fields upon which any calculation field depends may be detected, and the dependent calculation fields may be automatically recalculated, much like automatic recalculation functionality of popular spreadsheet programs. Thus, in an embodiment, spreadsheet-like automatic calculation of calculation fields may be supported, such that a user advantageously may not have to manually recalculate any fields on a form. In an advantageous embodiment, changes in one field may result in a propagation of changes to any dependent calculation field. An artisan will appreciate, in light of the foregoing, that multiple levels of propagations may occur, in chain-like fashion, from a single change in one field of a form, such as, for example, changing the value of the “Quantity” field 1015, resulting in an automatic recalculation of the “Subtotal” calculation field 1020, resulting in another automatic recalculation of the “Total” calculation field 1025.

An artisan will appreciate, in light of the foregoing, that any degree of chained propagations may occur, depending on the complexity of a form. For example, income tax forms typically have complex dependencies, such that the change of a single value on one line of an income tax form may result in changes propagating to, for example, 30 or more lines. Advantageously, any degree of dependency and complexity may be supported by functionality for automatically calculating dependent calculation fields when a field is changed. An artisan will appreciate, in light of the foregoing, that, as the number of dependencies increases, the difficulty of manually coding computer executable instructions for detecting the dependencies may increase exponentially. Advantageously, therefore, tools for automatically generating computer executable code for performing these functions may lead to substantially increased efficiency and productivity of an organization's computer programming resources.

In a preferred embodiment, executable computer code may be automatically generated to determine when a field has been updated upon which a calculation field depends, and for automatically recalculating the calculation field. As will be appreciated by an artisan in light of the foregoing disclosure, the algebraic notation in which a user enters a calculation may implicity indicate the fields upon which a calculation field depends. For example, as illustrated in FIG. 11, a user may define the “Subtotal” calculation field 1025 to be the result of the function “Multiply(Quantity, Unit Price).” In this example, the “Subtotal” calculation field 1025 is implicitly dependent on the “Quantity” and the “Unit Price.” From this information, dependency information may be recorded, in the form of a graph, a table, a linked list, an array, a tree structure, such as the parse object tree 1300, or any other data structure capable of recording dependency information. In an embodiment, each entry in the dependency information data structure may comprise a field of the form, and an associated recalculation function that may be run when the field is changed. For example, one entry in the dependency information data structure may associate the “Quantity” field 1015 with the “Calculate Subtotal” function of FIG. 14, such that whenever the “Quantity” field 1015 is changed, the “Calculate Subtotal” function may be executed. For example, an automatic recalculation function may execute the exemplary function “Calculate Subtotal” of FIG. 14 whenever either a “Quantity” or a “Unit Price” value changes. An artisan will appreciate, in light of the foregoing, that the resulting change in the “Subtotal” calculation field 1020 may trigger a similar automatic recalculation function associated with the dependent “Total” calculation field 1025. An artisan will appreciate, in light of the foregoing, that an advantageous mechanism ensures that any automatic recalculations are performed in an order that ensures the validity of each recalculation.

Several illustrative embodiments of a system and method for designing and generating calculation fields of electronic forms are disclosed in the foregoing. Advantageously, these embodiments may allow a computer user without programming expertise to construct calculation fields, while supporting powerful calculation capabilities. These embodiments are illustrative only, and are not intended to restrict the scope of the inventive embodiments of the generation of calculation fields of electronic forms. It is expected that many alternative embodiments may become apparent, in light of the foregoing, to one of ordinary skill in the art, and it is intended that these alternative embodiments are within the scope of this disclosure. Thus, the scope of the invention is defined by the following claims, and is not limited by the above description.

What is claimed is:

1. A method of providing an electronic version of a, form to a user over a computer network, the method comprising:
receiving data corresponding to a user's layout of an electronic version of a form, the data including one or more user input fields and one or more calculation fields, wherein the data does not need to include client-side computer executable code capable of performing calculations relating to the one or more calculation fields;
generating client-side computer executable code capable of performing at least one of the one or more calculations; and
transmitting the client-side computer executable code to a requester of the electronic version of the form.

2. The method of claim 1, wherein the generating of client-side computer executable code is performed in a server process.

3. The method of claim 1, wherein the computer executable code comprises JavaScript.

4. The method of claim 3, wherein the JavaScript is embedded in HTML.

5. The method of claim 4, wherein the HTML includes CSS.

6. The method of claim 4, wherein the HTML comprises a high fidelity representation of the form.

7. A system configured to provide an electronic version of a form to a user over a computer network, the system comprising:
means for receiving data corresponding to a user's layout of an electronic version of a form, the data including one or more user input fields and one or more calculation fields, wherein the data does not need to include client-side computer executable code capable of performing one or more calculations related to the one or more calculation fields;
means for generating client-side computer executable code capable of performing at least one of the one or more calculations; and
means for transmitting the client-side computer executable code to a requestor of the electronic version of the form.

8. The system of claim 7, wherein the means for generating client-side executable code resides in a server.

9. The system of claim 7, wherein the computer executable code comprises JavaScript.

10. The system of claim 9, wherein the JavaScript is embedded in HTML.

11. The system of claim 10, wherein the HTML includes CSS.

12. The system of claim 10, wherein the HTML comprises a high fidelity representation of the form.

13. A method of generating at least one calculation object descriptive of calculations to be performed on an electronic version of a form using a design tool, the method comprising:
receiving user input about design of an electronic form including graphic elements and at least one calculation element that uses data from at least one other portion of the electronic form to calculate a value of the calculation element;
associating the at least one calculation element with at least one of the graphic elements; and
storing the associated at least one calculation element in a format receivable as input for generation of client-side computer executable code capable of performing the at least one calculation.

14. The method of claim 13, wherein the at least one calculation is stored in at least one form object;

15. The method of claim 14, wherein the at least one form object is stored in a form template.

16. The method of claim 15, wherein the form template comprises XML.

17. The method of claim 15, wherein the form template further comprises form objects descriptive of graphic elements of the form and input and output elements of the form.

18. A system for generating at least one calculation object descriptive of calculations to be performed on an electronic version of a form using a design tool, the system comprising:
means for receiving user input about design of an electronic form including graphic elements and at least one calculation element that uses data from at least one other portion of the electronic form to calculate a value of the calculation element;
means for associating the at least one calculation element with at least one of the graphic elements; and
means for storing the associated at least one calculation element in a format receivable as input for generation of client-side computer executable code capable of performing the at least one calculation.

19. The system of claim 18, wherein the at least one calculation is stored in at least one form object;

20. The system of claim 19, wherein the at least one form object is stored in a form template.

21. The system of claim 20, wherein the form template comprises XML.

22. The system of claim 20, wherein the form template further comprises form objects descriptive of graphic elements of the form and input and output elements of the form.

23. A method of providing an electronic version of a form to a user over a computer network, the method comprising:
receiving data corresponding to a user's layout of an electronic version of a form, the data including one or more user input fields and one or more calculation fields, wherein the one or more calculation fields is represented in an algebraic notation;
generating client-side computer executable code capable of performing at least one of the one or more calculations; and
transmitting the client-side computer executable code to a requestor of the electronic version of the form.

24. A method of providing an electronic version of a form to a user over a computer network, the method comprising:
receiving data corresponding to a user's layout of an electronic version of a form, the data including one or more user input fields and one or more calculation fields, wherein the data is entered in a syntax that is commonly understood by a computer user without computer programming expertise;
generating client-side computer executable code capable of performing at least one of the one or more calculations; and
transmitting the client-side computer executable code to a requestor of the electronic version of the form.
